(19) United States
(12) Patent Application Publication
(10) Pub. No.: US 2009/0307873 A1
(43) Pub. Date: Dec. 17, 2009

(54) Hinge assembly with an oil-retaining collar

(75) Inventor: Po-Chuan Chen, Shulin City (TW)

Correspondence Address: COOPER & DUNHAM, LLP, 30 Rockefeller Plaza, 20th Floor, NEW YORK, NY, 10112, US

(73) Assignee: Shin Zu Shing Precision Electron (Suzhou) Co.,Ltd.

(21) Appl. No.: 12/214,089

(22) Filed: Jun. 17, 2008

(51) Int. Cl. E05D 11/02

(52) U.S. Cl. 16/274

(57) ABSTRACT

A hinge assembly with an oil-retaining collar has a barrel, a pintle assembly mounted in the barrel and an oil-retaining collar mounted around the barrel and is filled with lubricant to allow the pintle assembly to rotate smoothly. The oil-retaining collar prevents the lubricant from flowing out of the barrel and prevents a plastic housing of an electronic device from being corroded and electronics from malfunctioning.

### BACKGROUND OF THE INVENTION

1. Field of the Invention

The present invention relates to a hinge assembly, especially to a hinge assembly with an oil-retaining collar mounted around a barrel and a pivot assembly filled with lubricant.

2. Description of the Prior Arts

Electronic devices such as laptops, mobile phones, personal digital assistants (PDA), etc. have a base, a cover and a hinge. The hinge assembly connects the cover to the base to allow the cover to pivot relative to the base.

With reference to FIG. 7, a conventional hinge assembly (80) has a rotating bracket (81), a stationary bracket (82), a barrel (83) and a pintle assembly (84). The rotating bracket (81) is connected to the cover of the electronic device. The stationary bracket (82) is connected to the base of the electronic device. The barrel (83) is attached to the rotating bracket (81) and has a bushing (831) and at least one through hole (832). The bushing (831) is a resilient slotted cylinder. The through hole (832) is formed through the bushing (831). The pintle assembly (84) is attached to the stationary bracket (82), is mounted through the bushing (831) of the barrel (83) to allow the cover to pivot relative to the base and set the cover at any angle. The bushing (831) of the barrel (83) is filled with lubricant to prevent the barrel (83) and the pintle assembly (84) from wearing away and to keep the conventional hinge assembly (80) rotating smoothly.

However, lubricant may flow out of the conventional hinge assembly (80) from the through hole (832) of the bushing (831) of the barrel (83) causing the conventional hinge assembly (80) to rotate roughly and wear away once the lubricant is too little. Furthermore, the lubricant flowing out of the conventional hinge assembly (80) may touch and corrode a plastic housing of the electronic device or dirty electronics of the electronic device causing malfunctions.

To overcome the shortcomings, the present invention provides a hinge assembly with an oil-retaining collar to mitigate or obviate the aforementioned problems.

### SUMMARY OF THE INVENTION

The main objective of the present invention is to provide a hinge assembly with an oil-retaining collar that has a barrel, a pintle assembly mounted in the barrel and an oil-retaining collar mounted around the barrel and is filled with lubricant to allow the pintle assembly to rotate smoothly. The oil-retaining collar prevents the lubricant from flowing out of the barrel and prevents a plastic housing of an electronic device from being corroded and electronics from malfunctioning.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hinge assembly with an oil-retaining collar in accordance with the present invention;

FIG. 2 is an enlarged exploded perspective view of the hinge assembly in FIG. 1;

FIG. 3 is a top view in partial section of the hinge assembly in FIG. 1;

FIG. 4 is a perspective view of a second embodiment of a hinge assembly with an oil-retaining collar in accordance with the present invention;

FIG. 5 is an enlarged exploded perspective view of the hinge assembly in FIG. 4;

FIG. 6 is a top view in partial section of the hinge assembly in FIG. 4; and

FIG. 7 is an enlarged perspective view of a conventional hinge assembly in accordance with the prior art.

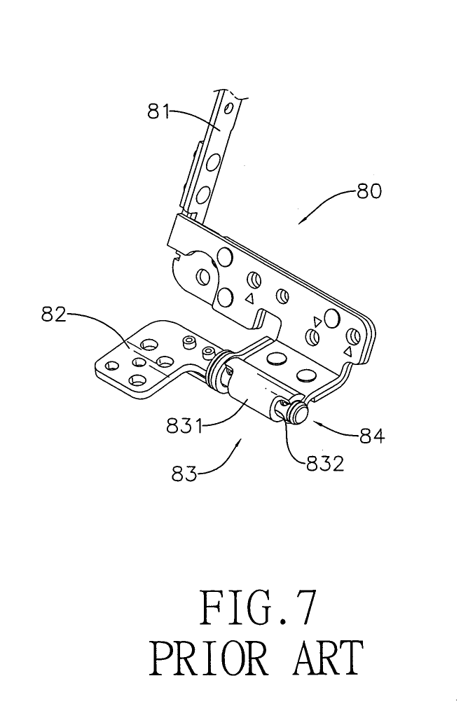

### DETAILED DESCRIPTION OF THE PREFERRED EMBODIMENTS

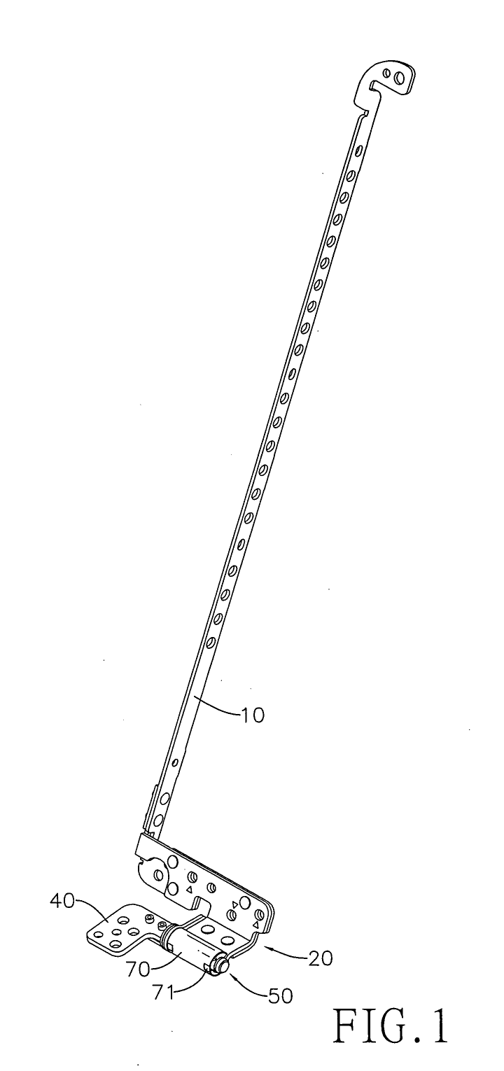

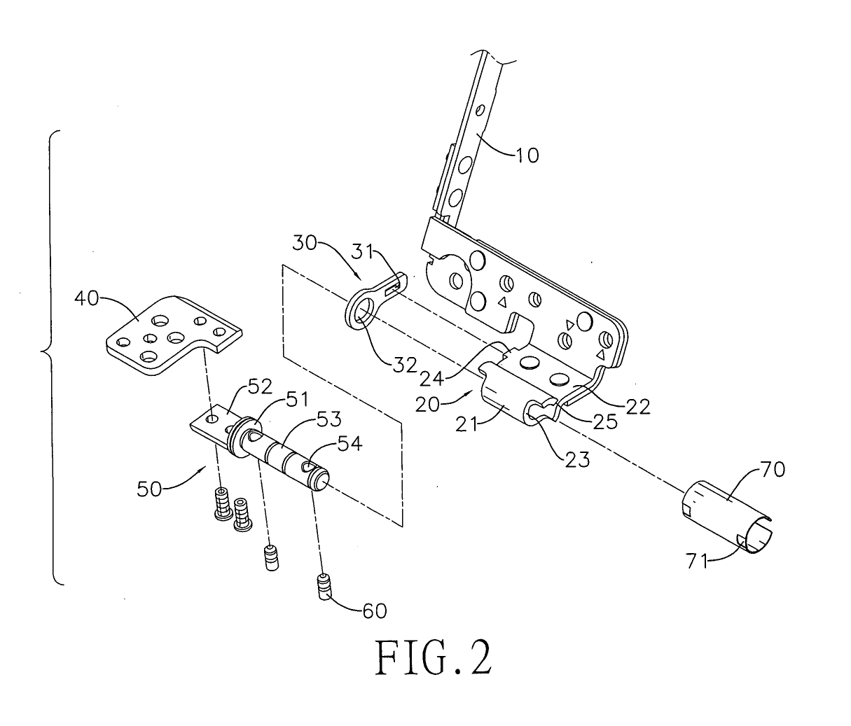

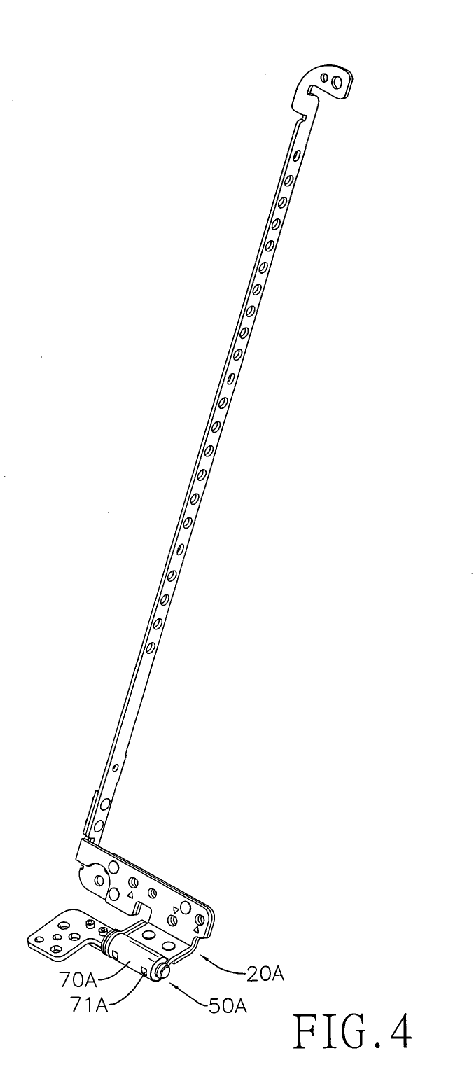

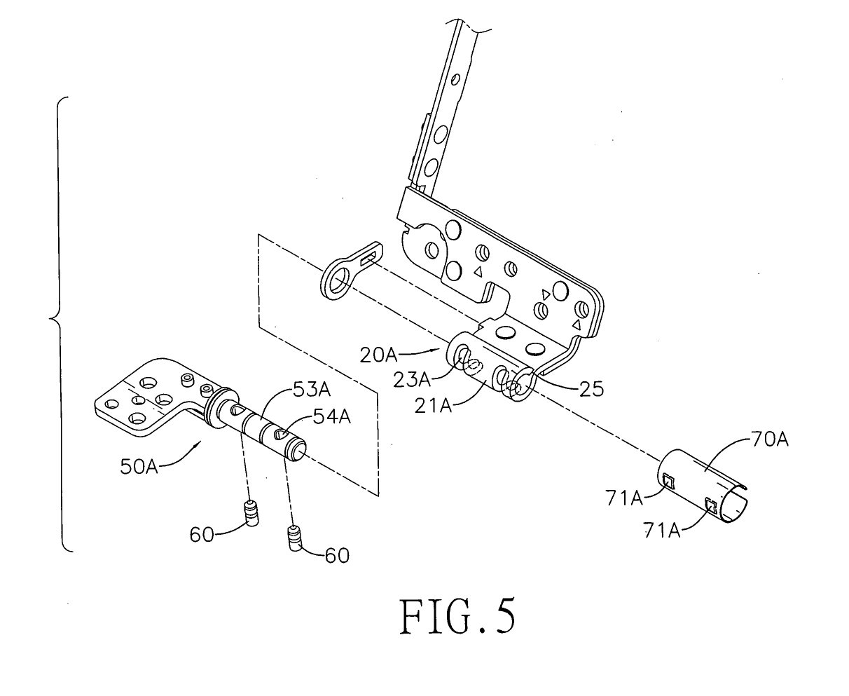

With reference to FIGS. 1, 2, 4 and 5, a hinge assembly with an oil-retaining collar in accordance with the present invention comprises an optional rotating bracket (10), a barrel (20, 20A), an optional connector (30), an optional stationary bracket (40), a pintle assembly (50, 50A), at least one optional limiting rod (60) and an oil-retaining collar (70, 70A).

The rotating bracket (10) is connected to a cover of an electronic device to allow the cover to pivot with the rotating bracket (10).

The barrel (20, 20A) may be attached to the rotating bracket (10) and has a bushing (21, 21A) and a neck (22).

The bushing (21, 21A) is a resilient slotted cylinder and has an outer surface, two ends, a longitudinal slot (25) and at least one through hole (23, 23A). The longitudinal slot (25) is formed longitudinally through the bushing (21, 21A). Each through hole (23, 23A) is formed through the bushing (21, 21A). The at least one through hole (23) may be a recess and adjacent to one end of the bushing (21). The at least one through hole (23A) may be a slot and is formed between the ends of the bushing (21A).

The neck (22) is formed longitudinally on and protrudes out from the outer surface of the bushing (21, 21A) adjacent to the longitudinal slot (25), may be attached to the rotating bracket (10) and may have a side edge and a positioning protrusion (24). The positioning protrusion (24) is formed on and protrudes from the side edge of the neck (22).

The connector (30) is mounted beside the barrel (20, 20A) adjacent to the side edge of the neck (22) of the barrel (20, 20A) and has a positioning hole (31) and a mounting hole (32). The positioning hole (31) is formed through the connector (30) and is mounted securely around the positioning protrusion (24) of the barrel (20, 20A). The mounting hole (32) is formed through the connector (30) and aligns with the bushing (21, 21A) of the barrel (20, 20A).

The stationary bracket (40) is connected to a base of the electronic device.

The pintle assembly (50, 50A) is mounted in the bushing (21, 21A) of the barrel (20, 20A), may be mounted through the mounting hole (32) of the connector (30), may be attached to the stationary bracket (40) and may have an enlarged head (51), a pivoting leaf (52), a pintle (53, 53A) and at least one limiting hole (54, 54A).

The enlarged head (51) has two opposite surfaces.

The pivoting leaf (52) is formed on and protrudes longitudinally from one of the surfaces of the enlarged head (51) and may be attached to the stationary bracket (40).

The pintle (53, 53A) is formed on and protrudes longitudinally from the other surface of the enlarged head (51), is larger than the bushing (21, 21A) of the barrel (20, 20A), is mounted through the mounting hole (32) of the connector (30) and in the bushing (21, 21A) of the barrel (20, 20A), expands the bushing (21, 21A) of the barrel (20, 20A) when mounted through the barrel (20, 20A) and holds the pintle assembly (50) tightly in the bushing (21, 21A) of the barrel (20, 20A).

The at least one limiting hole (54, 54A) is formed radially through the pintle assembly (50, 50A), may be formed radially through the pintle (53, 53A) and corresponds to the at least one through hole (23, 23A) of the bushing (21, 21A) of the barrel (20, 20A).

The at least one limiting rod (60) is mounted securely in the limiting hole (54, 54A) of the pintle assembly (50, 50A) and protrudes through the through hole (23, 23A) of the bushing (21, 21A) of the barrel (20, 20A) to limit a pivoting angle of the rotating bracket (10) and the barrel (20, 20A) relative to the pintle assembly (50, 50A) and the stationary bracket (40).

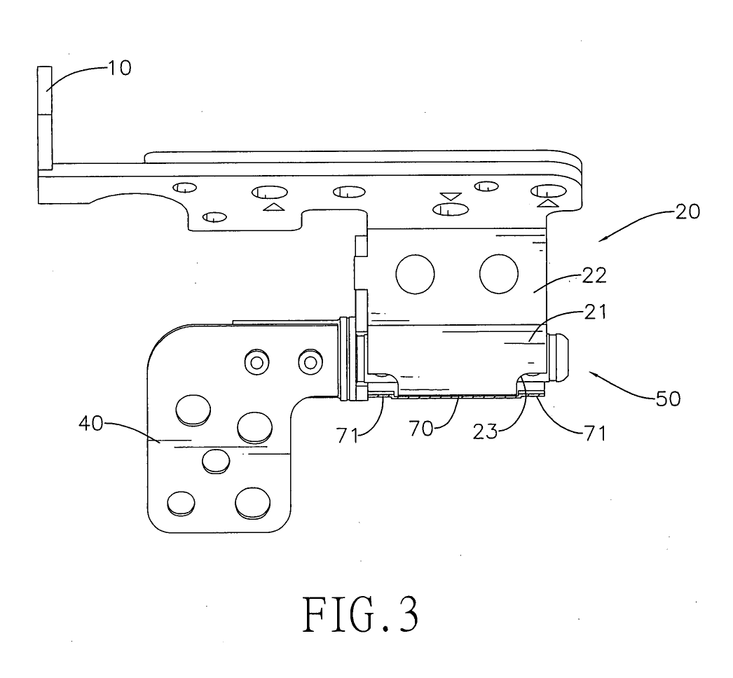

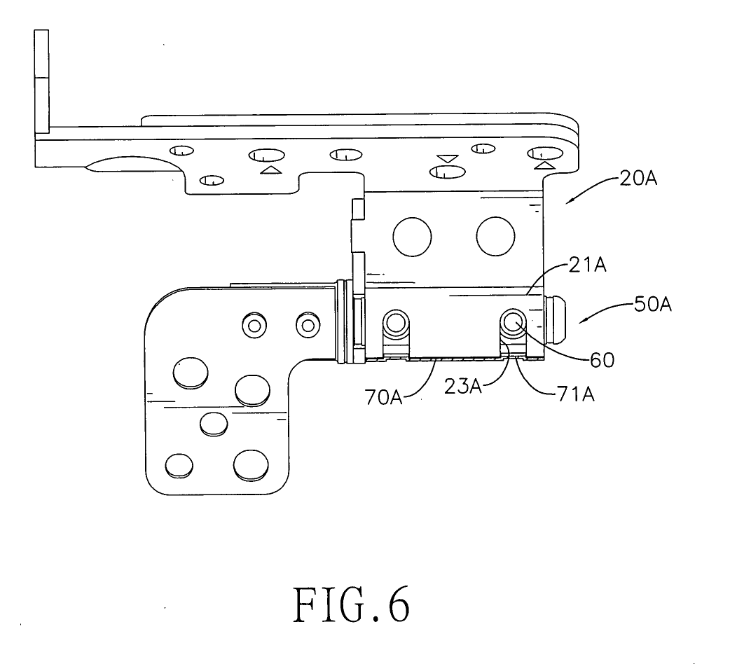

With further reference to FIGS. 3 and 6, the oil-retaining collar (70, 70A) is mounted around the bushing (21, 21A) of the barrel (20, 20A), is filled with lubricant and may have an inner surface, two ends and at least one protrusion (71, 71A). Each protrusion (71, 71A) is formed on the inner surface of the oil-retaining collar (70, 70A) and corresponds to and engages the through hole (23, 23A) of the bushing (21, 21A) of the barrel (20, 20A). The at least one protrusion (71) may be formed adjacent to the end of the oil-retaining collar (70). The at least one protrusion (71A) may be formed between the ends of the oil-retaining collar (70A).

The hinge assembly with an oil-retaining collar as described has the following advantages. The oil-retaining collar (70, 70A) is mounted around the bushing (21, 21A) of the barrel (20, 20A) and is filled with lubricant. The protrusion (71, 71A) of the oil-retaining collar (70, 70A) further engages in the through hole (23, 23A) of the bushing (21, 21A) of the barrel (20, 20A) and holds the oil-retaining collar (70, 70A) around the bushing (21, 21A) of the barrel (20, 20A). Therefore, the oil-retaining collar (70, 70A) prevents most of the lubricant from flowing out of the hinge, keeps the hinge assembly as described rotating smoothly and prevents a plastic housing of the electronic device from being corroded.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge assembly comprising
a barrel having
a bushing being a resilient slotted cylinder and having
an outer surface;
a longitudinal slot being formed longitudinally through the bushing; and
at least one through hole being formed through the bushing; and
a neck being formed longitudinally on and protruding out from the outer surface of the bushing adjacent to the longitudinal slot;
a pintle assembly being mounted in the bushing of the barrel; and
an oil-retaining collar being mounted around the bushing of the barrel.

2. The hinge assembly as claimed in claim 1, wherein the oil-retaining collar further has
an inner surface; and
at least one protrusion being formed on the inner surface of the oil-retaining collar and respectively corresponding to and engaging the at least one through hole of the bushing of the barrel.

3. The hinge assembly as claimed in claim 1, wherein
the pintle assembly further has-at least one limiting hole being formed radially through the pintle assembly and corresponding to the at least one through hole of the bushing of the barrel; and
the hinge assembly further has at least one limiting rod being respectively mounted securely in the at least one limiting hole of the pintle assembly and respectively protruding through the at least one through hole of the bushing of the barrel.

4. The hinge assembly as claimed in claim 2, wherein
the pintle assembly further has at least one limiting hole being formed radially through the pintle assembly and corresponding to the at least one through hole of the bushing of the barrel; and
the hinge assembly further has at least one limiting rod being respectively mounted securely in the at least one limiting hole of the pintle assembly and respectively protruding through the at least one through hole of the bushing of the barrel.

5. The hinge assembly as claimed in claim 1, wherein
the neck of the barrel further has
a side edge; and
a positioning protrusion being formed on and protruding from the side edge of the neck;
the hinge assembly further has a connector being mounted beside the barrel adjacent to the side edge of the neck of the barrel and having
a positioning hole being formed through the connector and being mounted securely around the positioning protrusion of the barrel; and
a mounting hole being formed through the connector and aligning with the bushing of the barrel; and
the pintle assembly is mounted through the mounting hole of the connector.

6. The hinge assembly as claimed in claim 2, wherein
the neck of the barrel further has
a side edge; and
a positioning protrusion being formed on and protruding from the side edge of the neck;
the hinge assembly further has a connector being mounted beside the barrel adjacent to the side edge of the neck of the barrel and having
a positioning hole being formed through the connector and being mounted securely around the positioning protrusion of the barrel; and
a mounting hole being formed through the connector and aligning with the bushing of the barrel; and
the pintle assembly is mounted through the mounting hole of the connector.

7. The hinge assembly as claimed in claim 3, wherein
the neck of the barrel further has
a side edge; and
a positioning protrusion being formed on and protruding from the side edge of the neck;
the hinge assembly further has a connector being mounted beside the barrel adjacent to the side edge of the neck of the barrel and having
a positioning hole being formed through the connector and being mounted securely around the positioning protrusion of the barrel; and
a mounting hole being formed through the connector and aligning with the bushing of the barrel; and
the pintle assembly is mounted through the mounting hole of the connector.

8. The hinge assembly as claimed in claim 4, wherein
the neck of the barrel further has
a side edge; and
a positioning protrusion being formed on and protruding from the side edge of the neck;
the hinge assembly further has a connector being mounted beside the barrel adjacent to the side edge of the neck of the barrel and having
a positioning hole being formed through the connector and being mounted securely around the positioning protrusion of the barrel; and
a mounting hole being formed through the connector and aligning with the bushing of the barrel; and
the pintle assembly is mounted through the mounting hole of the connector.

9. The hinge assembly as claimed in claim 5, wherein the pintle assembly further has
an enlarged head having two opposite surfaces;
a pivoting leaf being formed on and protruding longitudinally from one of the surfaces of the enlarged head; and
a pintle being formed on and protruding longitudinally from the other surface of the enlarged head, being larger than the bushing of the barrel, being mounted through the mounting hole of the connector and in the bushing of the barrel, expanding the bushing of the barrel when mounted through the barrel and holding the pintle assembly tightly in the bushing of the barrel.

10. The hinge assembly as claimed in claim 6, wherein the pintle assembly further has
an enlarged head having two opposite surfaces;
a pivoting leaf being formed on and protruding longitudinally from one of the surfaces of the enlarged head; and
a pintle being formed on and protruding longitudinally from the other surface of the enlarged head, being larger than the bushing of the barrel, being mounted through the mounting hole of the connector and in the bushing of the barrel, expanding the bushing of the barrel when mounted through the barrel and holding the pintle assembly tightly in the bushing of the barrel.

11. The hinge assembly as claimed in claim 7, wherein
the pintle assembly further has
an enlarged head having two opposite surfaces;
a pivoting leaf being formed on and protruding longitudinally from one of the surfaces of the enlarged head; and
a pintle being formed on and protruding longitudinally from the other surface of the enlarged head, being larger than the bushing of the barrel, being mounted through the mounting hole of the connector and in the bushing of the barrel, expanding the bushing of the barrel when mounted through the barrel and holding the pintle assembly tightly in the bushing of the barrel; and
the at least one limiting hole of the pintle assembly is formed radially through the pintle.

12. The hinge assembly as claimed in claim 8, wherein
the pintle assembly further has
an enlarged head having two opposite surfaces;
a pivoting leaf being formed on and protruding longitudinally from one of the surfaces of the enlarged head; and
a pintle being formed on and protruding longitudinally from the other surface of the enlarged head, being larger than the bushing of the barrel, being mounted through the mounting hole of the connector and in the bushing of the barrel, expanding the bushing of the barrel when mounted through the barrel and holding the pintle assembly tightly in the bushing of the barrel; and
the at least one limiting hole of the pintle assembly is formed radially through the pintle.

13. The hinge assembly as claimed in claim 9 further comprising
a rotating bracket being attached to the neck of the barrel; and
a stationary bracket being attached to the pivoting leaf of the pintle assembly.

14. The hinge assembly as claimed in claim 10 further comprising
a rotating bracket being attached to the neck of the barrel; and
a stationary bracket being attached to the pivoting leaf of the pintle assembly.

15. The hinge assembly as claimed in claim 11 further comprising
a rotating bracket being attached to the neck of the barrel; and
a stationary bracket being attached to the pivoting leaf of the pintle assembly.

16. The hinge assembly as claimed in claim 12 further comprising
a rotating bracket being attached to the neck of the barrel; and
a stationary bracket being attached to the pivoting leaf of the pintle assembly.
